(19) United States
(12) Patent Application Publication
(10) Pub. No.: US 2026/0161135 A1
(43) Pub. Date: Jun. 11, 2026

(54) SHOCK-RESISTANT BALANCE PLATE FOR A DIRECT IMPULSE ESCAPEMENT MECHANISM

(71) Applicant: Montres Breguet S.A., L'Abbaye (CH)

(72) Inventors: Quentin THEURILLAT-BONJOUR, Vallorbe (CH); Jérôme MACE, Le Pont (CH); Grégory GAUTHIER, Saint-Cergue (CH); Younes KADMIRI, Montfaucon (FR)

(73) Assignee: Montres Breguet S.A., L'Abbaye (CH)

(21) Appl. No.: 19/392,375

(22) Filed: Nov. 18, 2025

(30) Foreign Application Priority Data
Dec. 11, 2024 (EP) 24219038.7

(51) Int. Cl. G04B 15/14; G04B 43/00

(52) U.S. Cl. CPC G04B 15/14; G04B 43/002

(57) ABSTRACT

A balance plate (26) configured to engage with a direct impulse escapement mechanism (1), the balance plate (26) being fitted with a first impulse pallet stone (30) designed to engage with an escapement wheel (10) in the escapement mechanism (1), so that, in the impulse phase, the escapement wheel (10) gives the balance plate a direct impulse to actuate the balance (20), the first impulse pallet stone (30) being arranged radial to an axis of rotation (24) of the balance (20). The balance plate includes a rigid part (3) configured to be assembled to the balance (20), and a first elastically flexible part (5) on which the impulse pallet stone (30) is fitted, the first flexible part (5) being configured to enable the impulse pallet stone to move along the axis of rotation of the balance radially, in the event of a shock with the escapement wheel.

This application claims priority to European Patent Application No. 24219038.7, filed on December 11, 2024, the entire contents of which are incorporated herein by reference.

### Technical field of the invention

The present invention relates to a shock-resistant balance plate for engaging with a direct impulse escapement mechanism. The present invention also relates to a direct impulse escapement mechanism and to a horology movement comprising such an escapement mechanism.

### Technological background

In mechanical horology, various types of escapement mechanisms are used, the most common being the Swiss pallet escapement mechanism, which functions with an indirect impulse produced by a tooth on the escapement wheel against a pallet stone on the pallet.

There are other escapement mechanisms that function with a direct impulse, such as detent escapement, natural escapement, coaxial escapement or Robin escapement.

In these escapements, the balance plate comprises at least one impulse pallet stone engaging directly with the escapement wheel on the escapement mechanism.

The impulse pallet stone receives an impulse from a tooth on the escapement wheel to restart the balance. This impulse is generally oriented tangential to the escapement wheel.

However, as the balance plate is close to the escapement wheel, there is a risk of collision between the pallet stone and the escapement wheel in the event of a shock to the holder, as the balance is liable to move.

### Summary of the invention

The present invention aims to remedy the aforementioned problems by providing a balance plate for a direct impulse escapement mechanism capable of withstanding shocks.

To this end, the present invention relates to a balance plate configured to engage with a direct impulse escapement mechanism, the balance plate being fitted with an impulse pallet stone designed to engage with an escapement wheel in the escapement mechanism, so that, in the impulse phase, the escapement wheel gives the balance plate a direct impulse to actuate the balance, the first impulse pallet stone being arranged radial to an axis of rotation of the balance, the balance plate comprising a rigid part configured to be assembled to the balance,

The invention is remarkable in that the balance plate comprises a first elastically flexible part on which the impulse pallet stone is fitted, the first flexible part being configured to enable the impulse pallet stone to move along the axis of rotation of the balance, preferably substantially radially, in the event of a shock with the escapement wheel.

Thus, in the event of a shock between the escapement wheel and the impulse pallet stone on the plate, the first flexible part distorts to absorb the shock and prevent damage to the elements in play.

In fact, unlike the impulse from the escapement wheel, which is substantially tangential, the collision between the plate and the escapement wheel is substantially radial. Consequently, such a flexible part enables the shock to be absorbed without affecting the function of the direct impulse escapement mechanism.

According to a particular embodiment of the invention, the flexible part comprises a translation table on which the impulse pallet stone is suspended, the translation table comprising at least one flexible blade configured to prevent substantially tangential movement of the impulse pallet stone relative to the axis of rotation of the balance, in particular when the impulse is given by the escapement wheel.

According to a particular embodiment of the invention, the translation table comprises at least two flexible blades each arranged on a different side of the impulse pallet stone, each flexible blade connecting the impulse pallet stone to the rigid part to enable it to move by deflection of the flexible blades.

According to a particular embodiment of the invention, the translation table comprises at least one pair of flexible blades arranged on one side of the impulse pallet stone, each flexible blade connecting the impulse pallet stone to the rigid part to enable it to move by deflection of the flexible blades.

According to a particular embodiment of the invention, the translation table comprises two pairs of flexible blades each arranged on a different side of the impulse pallet stone, each flexible blade connecting the impulse pallet stone to the rigid part to enable it to move by deflection of the flexible blades.

According to a particular embodiment of the invention, the movement of the pallet stone is substantially radial relative to the axis of rotation of the balance.

According to a particular embodiment of the invention, the balance plate comprises a second impulse pallet stone extending in the plane of the balance plate.

According to a particular embodiment of the invention, the balance plate comprises a second flexible part on which the second impulse pallet stone is fitted.

According to a particular embodiment of the invention, the second flexible part is fitted with a second translation table comprising at least one flexible blade configured to prevent substantially tangential movement of the impulse pallet stone relative to the axis of rotation of the balance, in particular when the impulse is given by the escapement wheel.

According to a particular embodiment of the invention, the second translation table comprises at least two flexible blades each arranged on a different side of the second impulse pallet stone or on the same side of the second impulse pallet stone, each flexible blade connecting the second impulse pallet stone to the rigid part to enable it to move by deflection of the flexible blades.

According to a particular embodiment of the invention, the rigid part comprises arms arranged perpendicular to each other, the impulse pallet stone or stones being arranged between two arms on the rigid part.

According to a particular embodiment of the invention, the rigid part comprises an enlarged arm fitted with a balance pin.

According to a particular embodiment of the invention, the arms on the rigid part form a cross.

The invention also relates to a direct impulse escapement mechanism, the escapement mechanism comprising at least one rotationally mobile escapement wheel, the escapement mechanism comprising such a balance plate, the balance plate being rotationally mobile along the axis of rotation of the balance, so that in the impulse phase, the escapement wheel gives the balance plate a direct impulse to actuate the balance.

According to a particular embodiment of the invention, the escapement mechanism is a natural escapement comprising a second escapement wheel and a pallet.

The invention also relates to a horology movement comprising such a direct impulse escapement mechanism, for example a natural escapement mechanism.

### Brief description of the figures

Other characteristics and advantages of the present invention will become clearer from the following detailed description of an embodiment of a balance pallet stone for a natural escapement mechanism, this example being given purely by way of non-limiting illustration only in connection with the appended drawings in which:

FIG. 1 is a perspective view of a natural escapement comprising a shock-resistant balance plate according to a first embodiment of the invention;

FIG. 2 is another perspective view of the natural escapement in FIG. 1;

FIG. 3 is a top view of the natural escapement in FIG. 1;

FIG. 4 is a top view of the shock-resistant balance plate according to the first embodiment of the invention;

FIG. 5 is a perspective view of the first embodiment of a shock-resistant balance plate according to the invention;

FIG. 6 is a top view of a second embodiment of a shock-resistant balance plate according to the invention;

FIG. 7 is a top view of a third embodiment of a shock-resistant balance plate according to the invention.

### Detailed description of the invention

The invention relates to a shock-resistant balance plate 26 configured to engage an escapement wheel in a direct impulse escapement mechanism.

In the description below, the balance plate 26 is configured to function in a natural escapement mechanism, the functioning of which is described in detail in patent EP4105731.

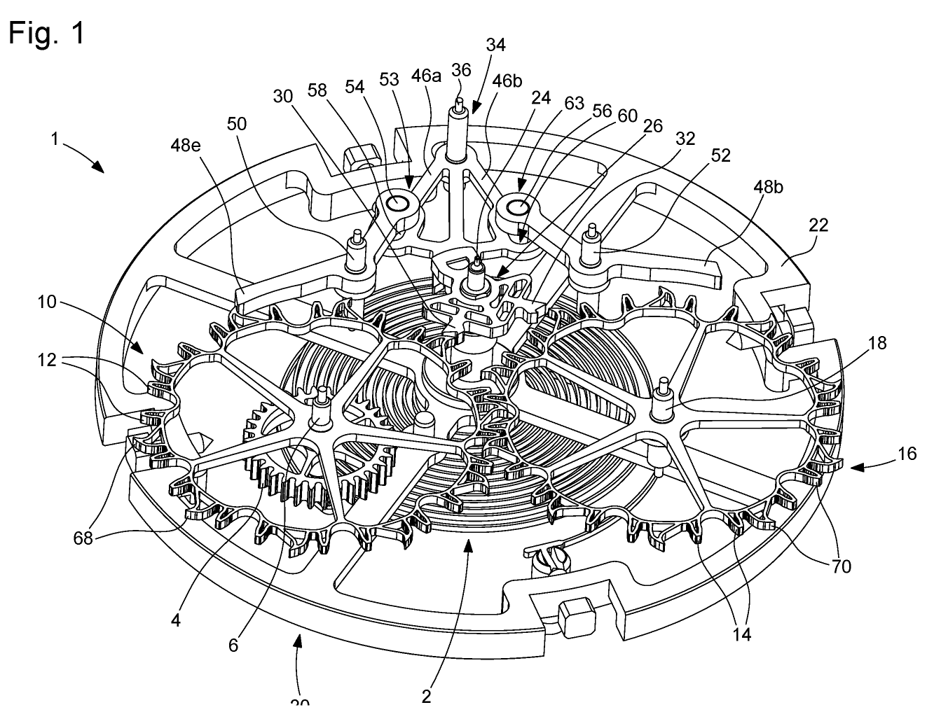

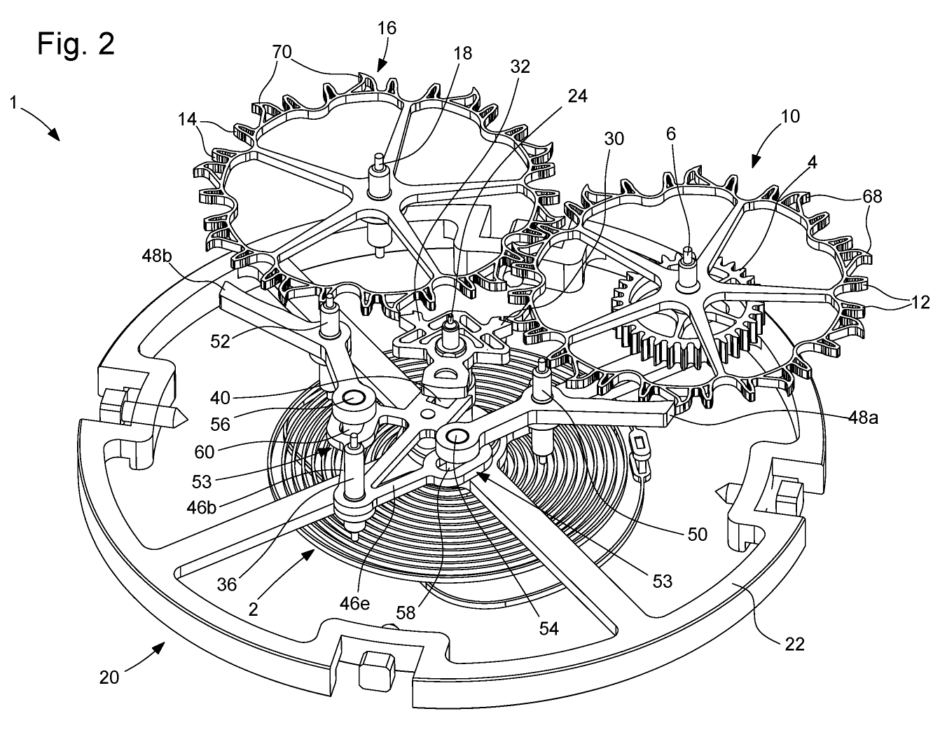

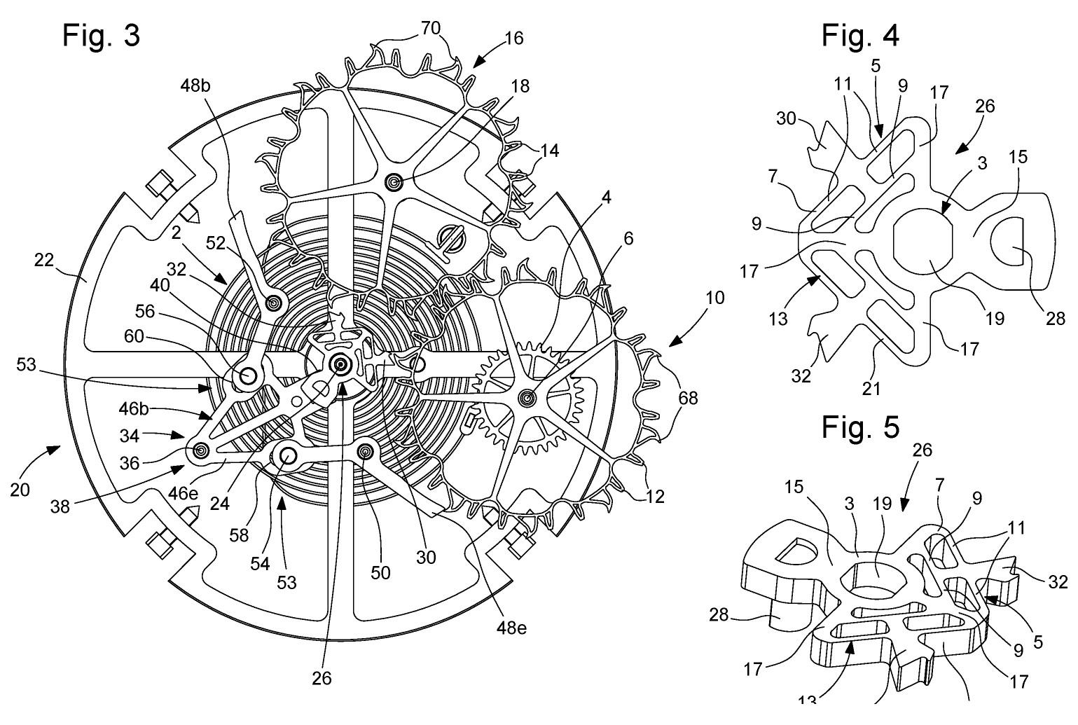

In FIGS. 1 to 3, referred to as a whole by the general numerical reference 1, the natural escapement is arranged to be driven by a drive mobile, not shown in the figures, that meshes with a pinion 4 fitted in a fixed position on an axis 6 of a first escapement wheel 10. This first escapement wheel 10 in turn meshes via a first drive toothing 12 with a second drive toothing 14 on a second escapement wheel 16 that pivots around an axis 18.

The natural escapement 1 also comprises a balance 20 that comprises a balance wheel 22 with a balance plate 26 fitted on an axis 24. This balance plate 26 carries a balance pin 28 as well as first and second impulse pallet stones 30 and 32, the respective roles of which will be described hereinafter. The impulse pallet stones are preferably rigid.

The natural escapement 1 also comprises a pallet 34 pivoted around a pallet arbor 36. This pallet 34 comprises a pallet body 38 that carries a fork 40 formed by a first and a second horn 42a and 42b as well as a dart 44. This dart 44 engages with the balance plate 26 to prevent accidental movement of the fork 40 outside the periods commonly referred to as supplementary arcs, and in which periods the balance plate 26 is close to its lock position, referred to as the lift angle.

The pallet body 38 comprises a first and a second arm 46a and 46b that are preferentially but non-limitatively arranged symmetrically on either side of the fork 40. First and second levers 48a, 48b, pivoted around respective pivot axes 50 and 52, are connected to the first and second arms 46a, 46b on the pallet body 38 via a pivot hinge 53. In this simplified embodiment, the first lever 48a is made in one piece and has a geometry that acts as a first stop pallet stone for temporarily locking the first escapement wheel 10 when the natural escapement 1 is in an operating cycle, and the second lever 48b has a geometry that acts as a second stop pallet stone for temporarily locking the second escapement wheel 16 when the natural escapement 1 is in the same operating cycle.

The first and second levers 48a, 48b each carry a catch 54, respectively 56, that protrudes into an oblong opening 58, respectively 60, in the first and second arms 46a, 46b on the pallet body 38. Of course, the catches 54 and 56 could be carried by the first and second arms 46a, 46b, and the oblong openings 58, 60 could be in the first and second levers 48a, 48b. Thus, when the catches 54, 56 engage in the oblong openings 58, 60, the first and second levers 48a, 48b can pivot relative to the first and second arms 46a, 46b on the pallet body 38.

In FIGS. 4 and 5, the first embodiment of the balance plate 26 comprises a rigid part 3. In this example, the rigid part 3 is cross-shaped and comprises four arms 15, 17 arranged perpendicular to each other.

The rigid part 3 comprises a central opening 19 so that it can be fitted on the axis 24 of the balance 20. An enlarged arm 15 comprises the balance pin 28. Each pallet stone 30, 32 is arranged between two of the three other arms 17.

According to the invention, the balance plate 26 comprises a first elastically flexible part 5, on which the first impulse pallet stone 30 is fitted.

Furthermore, the balance plate 26 comprises a second elastically flexible part 13, on which the second impulse pallet stone 32 is fitted.

Each flexible part 5, 13 is arranged between two arms 17 on the rigid part 15, for the corresponding impulse pallet stone 30, 32.

Each flexible part 5, 13 comprises a translation table 7, 21 on which an impulse pallet stone 30, 32 is suspended, and which comprises flexible blades 9, 11.

The translation table 7, 21 comprises at least one flexible blade 9 arranged on either side of the impulse pallet stone 30, 32. Each flexible blade 9 connects a different arm 17 on the rigid part 15 to an impulse pallet stone 30, 32. Preferably, the flexible blades 9 are arranged substantially perpendicular to each impulse pallet stone 30, 32 when the flexible part 5, 13 is in the lock position.

Preferably, each translation table 7, 21 comprises at least one pair of flexible blades 9, 11 arranged on each side of the pallet stone. The flexible blades 9, 11 are substantially parallel and arranged in the same plane, that of the balance plate 26.

The impulse pallet stones 30, 32 are arranged radially and extend in the same plane as that of the translation table 7, 21. The impulse pallet stones 30, 32 are arranged perpendicular to each other.

Consequently, if an escapement wheel 10, 16 collides with an impulse pallet stone 30, 32, the impulse pallet stone 30, 32 moves radially along the axis of rotation 24 of the balance 20 due to the deflection of the flexible blades 9, 11 on the translation tables 7, 21.

However, as the flexible blades 9, 11 are arranged tangentially to the axis of rotation 24 of the balance 20, these flexible parts 5, 13 substantially prevent tangential movement of the impulse pallet stones 30, 32 relative to the axis of rotation 24 of the balance 20.

The flexible part 5, 13 thus does not distort or distorts only slightly in this direction, such that a direct impulse given by the first escapement wheel 10 or the second escapement wheel 16 to an impulse pallet stone 30, 32 is transmitted to the balance 20, with minimal energy loss.

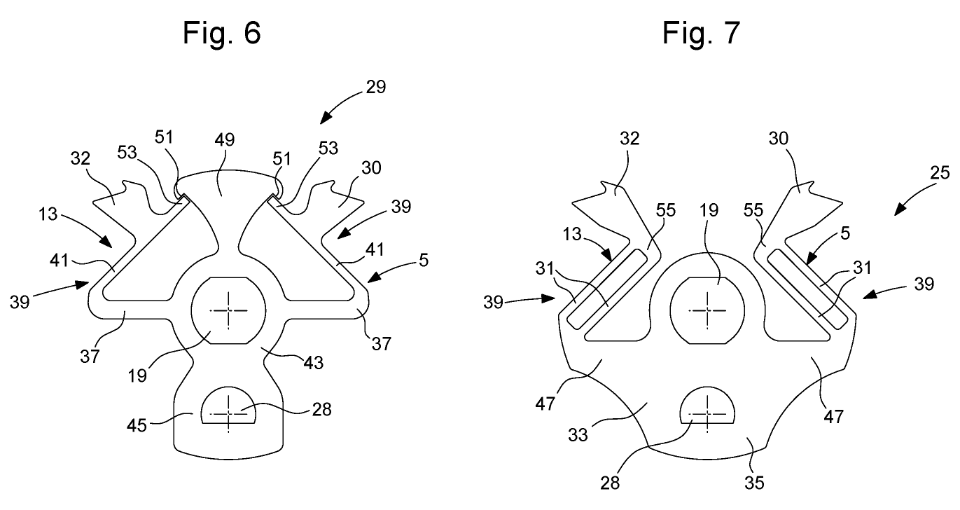

FIG. 6 shows a second embodiment of balance plate 29 fitted with two flexible parts 5, 13 each comprising a translation table 39 fitted with a single flexible blade 41 on which each pallet stone 30, 32 is suspended.

The rigid part 43 is cross-shaped and comprises a central opening 19, two lateral arms 37, one on each side of the central opening 19, a rear axial arm 45 fitted with the ellipse, and a front axial arm 49.

Each single flexible blade 41 connects a pallet stone 30, 32 to a lateral arm 37 on the different rigid part 35. Each single flexible blade 41 is connected at one end to one end of a lateral arm 37, and comprises a free end 53 that is mobile on the other side. The blades are oriented from the lateral arms 37 towards the front axial arm 49.

The pallet stones 30, 32 are arranged in the middle of the single flexible blade 41.

The front axial arm 49 is fitted with lateral stops 51 to block the free ends 53 of the flexible blades 41 so as to keep the flexible blades 41 from deflecting outwards. However, the flexible blades can distort towards the central opening 19.

The flexible blades 41 can be distorted by moving their free ends 53 closer to the central opening 19. Thus, in the event of a shock, the pallet stone 30, 32 is pushed back towards the axis of rotation 24 of the balance by the distortion of the single flexible blade 41.

The third embodiment in FIG. 7 shows a balance plate 25 comprising two pallet stones 30, 32 suspended by two flexible parts 5, 13. The flexible parts 5, 13 each comprise a translation table 39 comprising a pair of flexible blades 31 arranged on one side of the first impulse pallet stone 30. The rigid part 33 comprises two lateral arms 47 extending on either side of the central opening 19 and a rear portion 35 comprising the ellipse 28.

Each pallet stone 30, 32 is held on one side only by the two flexible blades 31 in the pair. The flexible blades 31 connect one end of the impulse pallet stone 30, 32 to the free end of a lateral arm 47 at the other end of the different rigid part 33, to enable it to move by deflection of the flexible blades 31.

Thus, in the event of a radial shock, the pallet stone 30, 32 is pushed back towards the axis of rotation 24 of the balance 20 by the distortion of the blades 31 in the pair of flexible blades.

Naturally, the invention is not limited to the plate embodiments described with reference to the figures, and variants could be envisaged without departing from the scope of the invention. For example, in one particular embodiment, the balance plate comprises a single impulse pallet stone configured to engage with an escapement mechanism comprising a single escapement wheel. Such an escapement mechanism is, for example, a detent escapement mechanism, or a coaxial escapement mechanism, or a Robin escapement mechanism, for which a single impulse pallet stone is required on the plate.

1. A balance plate configured to engage with a direct impulse escapement mechanism, the balance plate being fitted with a first impulse pallet stone designed to engage with an escapement wheel in the escapement mechanism, so that, in the impulse phase, the escapement wheel gives the balance plate a direct impulse to actuate the balance, the first impulse pallet stone being arranged radial to an axis of rotation of the balance, the balance plate comprising a rigid part configured to be assembled to the balance, wherein the balance plate comprises a first elastically flexible part on which the impulse pallet stone is fitted, the first flexible part being configured to enable the impulse pallet stone to move along the axis of rotation of the balance in the event of a shock with the escapement wheel.

2. The balance plate according to claim 1, wherein the first flexible part comprises a translation table on which the impulse pallet stone is suspended, the translation table comprising at least one flexible blade configured to prevent substantially tangential movement of the impulse pallet stone relative to the axis of rotation of the balance, in particular when the impulse is given by the escapement wheel.

3. The balance plate according to claim 2, wherein the translation table comprises at least two flexible blades each arranged on a different side of the impulse pallet stone, each flexible blade connecting the impulse pallet stone to the rigid part to enable it to move by deflection of the flexible blades.

4. The balance plate according to claim 2, wherein the translation table comprises at least one pair of flexible blades arranged on one side of the impulse pallet stone, each flexible blade connecting the impulse pallet stone to the rigid part to enable it to move by deflection of the flexible blades.

5. The balance plate according to claim 2, wherein the translation table comprises two pairs of flexible blades each arranged on a different side of the impulse pallet stone, each flexible blade connecting the impulse pallet stone to the rigid part to enable it to move by deflection of the flexible blades.

6. The balance plate according to claim 1, wherein the movement of the pallet stone is substantially radial relative to the axis of rotation of the balance.

7. The balance plate according to claim 1, further comprising a second impulse pallet stone extending in the plane of the balance plate.

8. The balance plate according to claim 7, further comprising a second flexible part on which the second impulse pallet stone is fitted.

9. The balance plate according to claim 8, wherein the second flexible part is fitted with a second translation table comprising at least one flexible blade configured to prevent substantially tangential movement of the second impulse pallet stone relative to the axis of rotation of the balance, in particular when the impulse is given by the escapement wheel.

10. The balance plate according to claim 9, wherein the second translation table comprises at least two flexible blades each arranged on a different side of the second impulse pallet stone or on the same side of the second impulse pallet stone, each flexible blade connecting the second impulse pallet stone to the rigid part to enable it to move by deflection of the flexible blades.

11. The balance plate according to claim 1, wherein the rigid part comprises arms arranged perpendicular to each other, the impulse pallet stone or stones being arranged between two arms on the rigid part.

12. The balance plate according to claim 11, wherein the rigid part comprises an enlarged arm fitted with a balance pin.

13. The balance plate according to claim 11, wherein the arms on the rigid part form a cross.

14. A direct impulse escapement mechanism, the escapement mechanism comprising at least one rotationally mobile escapement wheel, and the balance plate according to claim 1, the balance plate being rotationally mobile along the axis of rotation of a balance, so that in the impulse phase, the escapement wheel gives the balance plate a direct impulse to actuate the balance.

15. The direct impulse escapement mechanism according to claim 14, wherein the mechanism is a natural escapement comprising a second escapement wheel and a pallet.

16. A horology movement, comprising the direct impulse escapement mechanism according to claim 14.
